(19) United States
(12) Patent Application Publication
(10) Pub. No.: US 2011/0107823 A1
(43) Pub. Date: May 12, 2011

(54) SEALING FERRULE ASSEMBLY EXERTING GRIP ON CAPILLARY

(75) Inventor: Bernhard Dehmer, Rastatt (DE)

(73) Assignee: AGILENT TECHNOLOGIES, INC., Loveland, CO (US)

(21) Appl. No.: 13/002,533

(22) PCT Filed: Jul. 4, 2008
(86) PCT No.: PCT/EP2008/058639

§ 371 Date: Jan. 4, 2011

(51) Int. Cl. G01N 1/10; F16L 21/02

(52) U.S. Cl. 73/64.56; 285/342; 285/23

(57) ABSTRACT

A fitting for coupling a tubing to another component of a fluidic device, the fitting comprising a male piece having a front ferrule and a back ferrule both being slidable on the tubing, the male piece further having a first joint element configured slidably on the tubing, and a female piece having a recess configured for accommodating the front ferrule and the tubing and having a second joint element configured to be joinable to the first joint element, wherein the back ferrule is configured in such a manner that, upon joining the first joint element to the second joint element, the back ferrule exerts a pressing force on the front ferrule to provide a sealing between the front ferrule and the female piece, and the back ferrule exerts a grip force between the male piece and the tubing.

### BACKGROUND ART

The present invention relates to a fitting for a fluidic device.

In liquid chromatography, a fluidic analyte may be pumped through a column comprising a material which is capable of separating different components of the fluidic analyte. Such a material, so-called beads which may comprise silica gel, may be filled into a column tube which may be connected to other elements (like a control unit, containers including sample and/or buffers). During operation, such columns may be subjected to high pressures of, for instance, up to 600 bar and more.

Fittings for coupling different components, such as separation columns and conduits, of fluidic devices are commercially available and are offered, for instance, by the company Swagelok (see for instance http://www.swagelok.com).

U.S. Pat. No. 6,494,500 discloses a universal self-adjusting high pressure liquid connector for use with high pressure liquid chromatography (HPLC) columns requiring liquid-tight and leak free seals between fittings and unions. The apparatus provides a liquid-tight seal between the end of a HPLC end fitting and an end cap thereby eliminating any potential dead volume in the area of the connection. The apparatus comprises a body, a fixed ferrule, a replaceable ferrule, a stem disposed in the body and a biasing spring slidingly mounted on a capillary tube of that extends through the connector. The spring biases the capillary tube of the connector into the HPLC end fitting, self-adjusting and maintaining a pressure sufficient to ensure a liquid-tight seal notwithstanding the depth of the HPLC tube stop or ferrule stop of the mating HPLC column.

WO 2005/084337 discloses a coupling element comprising a male sealing element. The male sealing element comprises a first end, second end, and a longitudinal axis extending between the first and second end. The coupling element is housed within a nut. The male sealing element may have a generally cylindrical shape. Also, the male sealing element defines a fluid passageway therethrough for the transmission of fluid. The male sealing element is secured to a ferrule which is located within a cavity of the nut. The first end of the male sealing element defines a conical sealing surface. The male conical sealing surface may mate with a female sealing element which has a receptacle that is defined by a nearly complementary conical geometry. The male conical sealing surface may have a mismatched angle when compared to the complementary conical female sealing element. The coupling element also has a biasing element disposed between a retaining ring and the ferrule located within the nut cavity. This biasing element facilitates a fluid-tight, metal to metal (or metal to plastic, or plastic to plastic) seal between the male sealing element and female sealing element.

However, the requirements regarding sealing performance and mechanical stability of a fitting of fluidic measurement devices increases with further increasing operation pressure values.

### DISCLOSURE

It is an object of the invention to provide an efficient fitting for a fluidic device. The object is solved by the independent claims. Further embodiments are shown by the dependent claims.

According to an exemplary embodiment of the present invention, a fitting (or a connector) for coupling a tubing (such as a capillary) to another component (for instance a chromatographic column) of a fluidic device (such as a liquid chromatography device) is provided, the fitting comprising a male piece having a front ferrule and a back ferrule both being configured to be slidable on the tubing, the male piece further having a first joint element configured to be slidable on the tubing, and a female piece having a recess configured for accommodating the front ferrule and the tubing and having a second joint element configured to be joinable to the first joint element, wherein the back ferrule is configured in such a manner that, upon joining the first joint element to the second joint element, the back ferrule exerts a pressing force on the front ferrule (for instance as a result of a pressing force exerted by the first joint element on the back ferrule when the first joint element is joint to the second joint element) to provide a sealing between the front ferrule and the female piece, and the back ferrule exerts a grip force between the male piece and the tubing.

According to another exemplary embodiment, a fluidic device for processing a fluidic sample is provided, the fluidic device comprising a tubing for conducting the fluidic sample, another component for processing the fluidic sample, and a fitting having the above mentioned features for coupling the tubing to the other component.

According to still another exemplary embodiment, a method of coupling a tubing to another component of a fluidic device (for instance in a liquid-tight manner) is provided, the method comprising sliding a male piece having a front ferrule and a back ferrule on the tubing, and sliding a first joint element of the male piece on the tubing, providing a female piece having a recess configured for accommodating the front ferrule and the tubing and having a second joint element configured to be joinable to the first joint element, and joining the first joint element to the second joint element in such a manner that the back ferrule exerts a pressing force on the front ferrule to provide a sealing between the front ferrule and the female piece, and that the back ferrule exerts a grip force between the male piece and the tubing.

According to an exemplary embodiment, a fluid tight sealing employable even under high pressure conditions may be provided in which a male piece (having a protrusion-like shape and comprising an inner lumen) may be slid over a tubing to be connected to another component having a female piece (including a recess for at least partially accommodating the male piece) which may be slid as well over the tubing in an opposite direction as compared to the male piece. A first joint element of the male piece having a fastening feature such as an outer thread may then be connected to a second joint element of the female piece having a corresponding fastening feature such as an inner thread. By fastening the first joint element to the second joint element, a front ferrule of the male piece may be pressed against the female piece to provide a fluid-tight sealing there. Simultaneously and automatically, fastening the joint elements to one another may force the back ferrule to be radially pressed against the tubing, thereby fastening the fitting to the tubing by a resulting circumferential grip force. By taking these measures, it is possible to provide an easily operable fitting architecture which is capable of withstanding high pressures of several hundreds to thousand bars, and is therefore particularly appropriate for connecting different fluidic portions of a fluidic device such as a liquid chromatography apparatus.

According to an exemplary embodiment, a connection of a capillary to a member of a fluidic device in a pressure tight manner may be made possible, for instance at any desired fluidic position between a pump and a fractioner of a liquid chromatography device. According to the described fitting architecture, undesired contamination of leaking fluidic samples may be safely prevented by the simultaneous generation of a form closure or positive locking between tubing and back ferrule, and a transmission of a longitudinal force in a forward direction to seal the front ferrule against the female part. Furthermore, in an abutment portion between front ferrule and back ferrule, a (for instance slanted, alternatively vertical or upright or in any other configuration) spring component of the back ferrule may store a force which can be used to maintain the fluid-tight sealing even in a scenario in which a tension of the front ferrule (which may be made of a polymer) is weakened. Such an embodiment may have the further advantage that it is reversibly operable, particularly that by disconnecting the two connected joint elements, the capillary may be slid again and the arrangement may be disassembled with a single hand movement. Exemplary embodiments may be operable even by an unskilled user. It may be sufficient to manually slide the front and back ferrule over the capillary and to fasten the joint elements to one another, for instance by a screwing actuation. This may ensure a tight sealing and at the same time a safe prevention of an undesired sliding of a tubing.

According to an exemplary embodiment, a fitting for a capillary tube with a back ferrule may be provided, wherein the back ferrule may press against the front ferrule to provide for a hydraulic sealing. Simultaneously, the back ferrule may exert a force on the capillary to lock the capillary with the fitting.

Next, further exemplary embodiments of the fitting will be explained. However, these embodiments also apply to the fluidic device and to the method.

The front ferrule and the back ferrule may be fixedly connected to one another to form a single piece. In other words, front ferrule and back ferrule may be integrally formed to simplify operation of the fitting, since the user only has to slide a common front ferrule/back ferrule arrangement over the tubing.

The front ferrule may have a conically tapered front part configured to correspond to a conical portion of the recess of the female piece. Thus, corresponding shapes of a protrusion of the front ferrule and a recess of the female piece may be provided contributing to the fluid tight sealing.

In addition to the conically tapered front part, the front ferrule may have a conically tapered back part configured to correspond (for instance to be aligned in parallel) to a slanted annular front spring (such as a disk spring) of the back ferrule. In other words, the conically tapered back part of the front ferrule may be shaped and dimensioned to align to the slanted annular front spring of the back ferrule. By this force-free configuration, it may be ensured that the slanted annular front spring is moved upwardly by the application of a force, thereby storing force or potential energy allowing to maintain a reliable sealing even when the mechanical stability of the front ferrule is weakened over time.

The front ferrule may have a lumen configured for accommodating the tubing. Thus, the front ferrule may be provided with a cylindrical recess shaped and dimensioned to receive the tubing with clearance.

The front ferrule may comprise an elastic material such as a polymer material. Such a material may be, for instance, PEEK (polyetheretherketone) which may have a sufficient mechanical rigidity but also has sufficient flexibility to snuggle to the female part to provide a robust sealing. A polymer based front ferrule may allow to be elastically or plastically deformed and behave similar like a hydraulic medium. In view of the soft properties of the front ferrule, the front ferrule may align to the back ferrule to provide for a two-dimensional contact, and a force transmission over a large coupling surface. This may result in smaller gaps of the assembled structure, making it more difficult for any component to be pressed into such gaps which is usually undesired.

The back ferrule may be configured in such a manner that, upon joining the first joint element to the second joint element, the back ferrule exerts a pressing force on the front ferrule to provide a sealing between the front ferrule and the tubing, in addition to a sealing between the front ferrule and the female part. Thus, fastening the male part with the female part not only exerts a grip between back ferrule and tubing but also presses the front ferrule towards the tubing by an impact of the back ferrule. This promotes prevention of an undesired sliding of the capillary relative to the fitting and at the same ensures for a high pressure sealing.

The back ferrule may be configured in such a manner that, upon joining the first joint element to the second joint element, the back ferrule generates a positive locking force between the male piece and the tubing. This may fasten the fitting at the tubing in a secure manner.

The back ferrule may comprise a slanted annular front spring configured to correspond to (for instance to be aligned parallel to) a conically tapered back part of the front ferrule. However, this for instance slanted annular front spring may be adapted for being bent, upon joining the first joint element to the second joint element, into or towards an upright (or alternatively slanted) position to promote a forward motion of the front ferrule towards a stopper portion of the recess of the female piece. Thus, the upward pivoting of the slanted front spring may bias the latter, thereby maintaining the adjacent front ferrule abutting against the stopper portion of the female part.

The back ferrule may comprise an annular back spring. This annular back spring may be adapted to promote, upon joining the first joint element to the second joint element, a forward motion of the tubing towards a stopper portion of the recess of the female piece. This double spring configuration (back spring and front spring) provides for a seal and also ensures a fastening of the tubing at the fitting. Both the annular back spring and the annular front spring coupled through a sleeve element may act similarly to spring washers or disk springs.

The system may allow to adjust the functions of the front spring and of the back spring of the back ferrule independently from one another. This may allow to independently adjust both sealing sections profiting of an intentional over-determination of the system.

The back ferrule may comprise a sleeve element connecting the annular back spring with the slanted annular front spring. Such a sleeve element may have a hollow cylindrical shape and serve as a leaf spring exerting the grip force onto the tubing (which may be a metal capillary). Preferably, the sleeve element comprises two or more separating slots dividing a lateral surface of the sleeve element into two or more segments serving as flat spring elements.

The sleeve element may have a structured or patterned surface promoting a grip force to mechanically connect the back ferrule with the tubing. By structuring the surface of the sleeve element, for instance by providing separating slots, concentrically arranged grooves, concentrically arranged rips, a helical groove, a helical rip, or the like, a selective mechanical weakening or reinforcement of the sleeve element may be adjusted, thereby allowing the sleeve element to be easily bent with moderate forces, hence simplifying the application of a precise and sufficiently strong gripping force onto the tubing.

The sleeve element may have a functionalized surface promoting a grip force to mechanically connect the back ferrule with the tubing. Such a functionalized surface may include a surface coating or a surface hardening. Such provisions may contribute to the reliable prevention of lateral motions of the tubing and may reduce abrasive wear, when the male part and the female part are connected to one another.

The sleeve element may be conically tapered (along a direction parallel to a central axis of the tubing) and may have a thicker portion facing the first joint element as compared to a thinner portion facing the front ferrule. Such a configuration may mechanically reinforce the back ferrule, since a spatially dependent force distribution along the sleeve element during operation of the fitting may result in a different load or strain acting on different portions of the sleeve element.

The back ferrule may have a lumen configured for accommodating the tubing. Thus, similarly as in case of the front ferrule, the lumen may be slightly larger than an exterior dimension of the tubing so that the back ferrule can be slid over the tubing with some clearance.

The back ferrule may comprise an elastic material, particularly a metal material being sufficiently thin, such as a metal sheet, which preferably comprises recesses to form separate segments functioning as leaf springs. This metal may be of sufficiently small thickness so that a sufficient flexibility remains which allows particularly a central portion of the back ferrule to exert a gripping force onto the tubing.

The back ferrule may comprise a multiple spring configuration, particularly may comprise two disk springs separated by a flat spring or leaf spring. The disk springs may contribute to a force transmission in a direction parallel to a central axis of the tubing, whereas the flat spring may be bent perpendicular to a longitudinal axis of the tubing (for instance may be bent inwardly when the joint elements are connected), thereby providing for the grip.

The first joint element may be configured for being joined to the second joint element by screwing. A screw joint may be easily operable even by an unskilled operator. Alternative connection techniques may be a snap-in connection, a magnetic connection, etc.

The first joint element may comprise an external screw thread configured for a screw joint with an internal screw thread in the recess of the second joint element. Alternatively, the first joint element may have an internal screw thread cooperating with an external screw thread of the second joint element.

The first joint element may have an inner lumen configured for accommodating the tubing. Thus, also the first joint element may be slid over the tubing for assembling the fitting, with sufficient clearance.

The first joint element may comprise a rigid material, particularly a metal material. This may allow to provide a sufficient stability for a pressure tight connection of the fitting to components of a fluidic device.

The first joint element may have a slanted front face configured for exerting a bending moment on a non-slanted annular back spring of the back ferrule. By taking this measure, a spring-loaded force transmission or energy storage can be set so that longitudinally fastening the two joint elements vertically fastens the back ferrule against the tubing, longitudinally seals the front ferrule against the female part, and vertically fastens the front ferrule against the tubing even when creeping or settling of the involved elements occurs over a period of time. The slanted front face of the first joint element may be aligned in parallel to a slanted annular front spring of the back ferrule.

The slanted front face may include an acute angle with an outer surface of the tubing. An acute angle may be an angle between 0 and 90°, excluding the values of 0° and of 90°. For example, the acute angle may be 60°. Such a configuration exerts a pressing force onto an upper portion of the annular back spring, thereby transmitting the force in the forward direction in a desired manner.

The recess of the female part may be configured for accommodating also the back ferrule and a part of the first joint element. Thus, the recess in the female part may be sized and dimensioned so that the back ferrule and the first joint element may be accommodated within the recess.

The back ferrule may be arranged to be slidable on the tubing between the front ferrule and the first joint element. In an embodiment, back ferrule and front ferrule may be integrally formed. In another embodiment, they may be provided as two different pieces, which may then be slid onto the tubing in an order that the front ferrule is arranged in front of the back ferrule and the back ferrule is arranged in front of the first joint element.

The tubing may comprise a metal (such as stainless steel or titan), a plastic (such as polymer), glass or quartz material. In an embodiment, a metallic tubing may be provided which can have the capability of withstanding high pressures of, for instance 600 bar or 1.200 bar, thereby making the fitting appropriate for HPLC applications (High Performance Liquid Chromatography).

The tubing may have a lumen with an inner diameter of less than basically 0.8 mm, particularly of less than basically 0.2 mm, particularly for HPLC applications. This may allow the conduction of microfluidic samples through the tubing. For preparative separations, the tubing may have a lumen with an inner diameter of less than basically 5 mm, particularly of less than basically 1.0 mm.

The male piece may have an optional force transmission element (which may be formed by one or more additional spring elements providing a part of the spring load and allowing for an increased elastic spring travel) arranged slidable on the tubing between the back ferrule and the first joint element to transmit a force exerted by the first joint element to the back ferrule. Such a force transmission element (which may be realized as one or more springs) may be either integrally formed with the two ferrules, or may be provided as an element separate from the front and back ferrule configuration. The force transmission element may be configured as a metal ring or a flat washer promoting the force transmission between the components. More particularly, the force transmission element may be annularly shaped to correspond (regarding size, shape and orientation) to an annular back spring of the back ferrule. The annular back spring of the back ferrule and the force transmission element may be two disk-like bodies being arranged parallel to one another. Such additional one or more additional springs may be considered to be serially or parallel connected to the springs of the back ferrule. Consequently, the back ferrule may be configured more flexible which may increase the spring travel. The additional one or more additional springs may be used as a design parameter for adjusting or optimizing spring properties of the entire system. Particularly, the ratio between crimp force and forward force may be designed in accordance with a particular application.

The sleeve element may preferably comprise a plurality of slits to separate a lateral surface of the sleeve element to thereby form a plurality of leaf spring sections between adjacent ones of the plurality of slits. Under exertion of a force, theses leaf springs may be bent to abut against the tubing, and the dimension of the slits may be reduced or even closed to act as an mechanical stop. Such a slit formation in combination with the adjacent front and back spring may enable the provision of torque allowing for the generation of a grip.

Next, further exemplary embodiments of the fluidic device will be explained. However, these embodiments also apply to the fitting and to the method.

Fluidic devices according to exemplary embodiments may be particularly suitable for use as fluidic connection pieces for connecting parts of a fluidic instrument such as a liquid chromatographic system or the like. For example, columns, fractioners, detectors, etc., of a liquid chromatography apparatus may be connected to a tubing by such fittings.

A component to be coupled to the tubing by the fitting may be a fluidic sample processing element such as a separation column. Such a separation column may include material which may also be denoted as a stationary phase which may be any material which allows an adjustable degree of interaction with a sample so as to be capable of separating different components of such a sample. The separating material may be a liquid chromatography column filling material or packing material comprising at least one of the group consisting of polystyrene, zeolite, polyvinylalcohol, polytetrafluorethylene, glass, polymeric powder, silicon dioxide, and silica gel, or any of above with chemically modified (coated, capped etc) surface. However, any packing material can be used which has material properties allowing an analyte passing through this material to be separated into different components, for instance due to different kinds of interactions or affinities between the packing material and fractions of the analyte.

At least a part of the processing element may be filled with such a fluid separating material, wherein the fluid separating material may comprise beads having a size in the range of essentially 1 μm to essentially 50 μm. Thus, these beads may be small particles which may be filled inside the separation section of the microfluidic device. The beads may have pores having a size in the range of essentially 0.01 μm to essentially 0.2 μm. The fluidic sample may be passed through the pores, wherein an interaction may occur between the fluidic sample and the pores.

The fluidic device may be adapted as a fluid separation system for separating components of the sample. When a mobile phase including a fluidic sample passes through the fluidic device, for instance with a high pressure, the interaction between a filling of the column and the fluidic sample may allow for separating different components of the sample, as performed in a liquid chromatography device.

However, the fluidic device may also be adapted as a fluid purification system for purifying the fluidic sample. By spatially separating different fractions of the fluidic sample, a multi-component sample may be purified, for instance a protein solution. When a protein solution has been prepared in a biochemical lab, it may still comprise a plurality of components. If, for instance, only a single protein of this multi-component liquid is of interest, the sample may be forced to pass the columns. Due to the different interaction of the different protein fractions with the filling of the column (for instance using a gel electrophoresis device or a liquid chromatography device), the different samples may be distinguished, and one sample or band of material may be selectively isolated as a purified sample.

The fluidic device may be adapted to analyze at least one physical, chemical and/or biological parameter of at least one component of the mobile phase. The term “physical parameter” may particularly denote a size or a temperature of the fluid. The term “chemical parameter” may particularly denote a concentration of a fraction of the analyte, an affinity parameter, or the like. The term “biological parameter” may particularly denote a concentration of a protein, a gene or the like in a biochemical solution, a biological activity of a component, etc.

The fluidic device may be implemented in different technical environments, like a sensor device, a device for chemical, biological and/or pharmaceutical analysis, a capillary electrophoresis device, a liquid chromatography device, a gas chromatography device, or a mass spectroscopy device. Particularly, the fluidic device may be a High Performance Liquid device (HPLC) device by which different fractions of an analyte may be separated, examined and analyzed.

The fluidic device may be adapted to conduct the mobile phase through the system with a high pressure, particularly of at least 600 bar, more particularly of at least 1200 bar.

The fluidic device may be adapted as a microfluidic device. The term “microfluidic device” may particularly denote a fluidic device as described herein which allows to convey fluid through microchannels having a dimension in the order of magnitude of less than 800 μm, particularly less than 200 μm, more particularly less than 100 μm or less than 50 μm or less.

### BRIEF DESCRIPTION OF DRAWINGS

Other objects and many of the attendant advantages of embodiments of the present invention will be readily appreciated and become better understood by reference to the following more detailed description of embodiments in connection with the accompanied drawings. Features that are substantially or functionally equal or similar will be referred to by the same reference signs.

FIG. 1 illustrates a cross-sectional view of a fitting according to an exemplary embodiment.

FIG. 2 illustrates a three-dimensional view of a front ferrule and back ferrule arrangement of the fitting of FIG. 1.

FIG. 3 illustrates a high performance liquid chromatography apparatus according to an exemplary embodiment.

The illustration in the drawing is schematically.

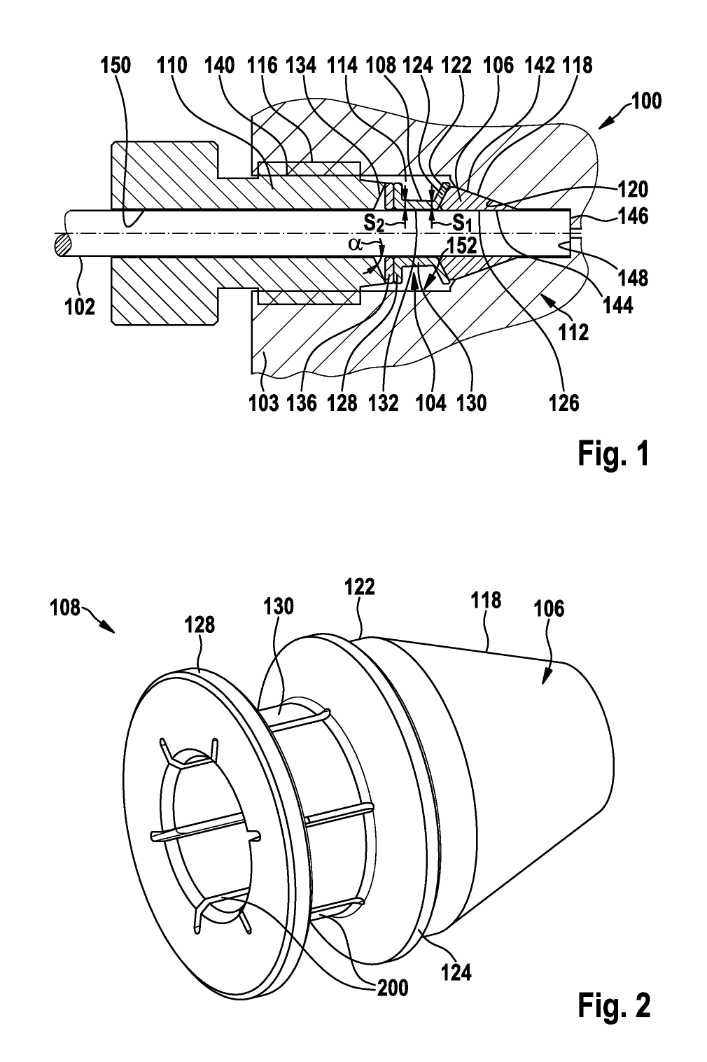

FIG. 1 shows a high pressure fitting 100 for coupling a metal tubing 102 (having a (not shown) inner fluid channel for conducting a fluidic sample) to a chromatographic column (not shown, but arranged on the right hand side of FIG. 1) of a liquid chromatography device according to an exemplary embodiment.

The fitting 100 comprises a male piece 104 having a front ferrule 106 made of a polymer material and having a back ferrule 108 made of a metallic material. The front ferrule 106 and the back ferrule 108 are integrally formed and are slidable together over the metal tubing 102. Moreover, the male piece 104 has a first joint element 110 configured slidably on the tubing 102. Thus, for mounting the fitting 100 on the tubing 102, the integrally formed front ferrule-back ferrule configuration 106, 108 is slid over the tubing 102, and subsequently the first joint element 110 is slid on the tubing 102. The front ferrule 106, the back ferrule 108 and the first joint element 110 together constitute the male piece 104.

After having slid the male piece 104 over the tubing 102, a female piece 112 having a recess 114 may be slid over the tubing 102 from the right-hand side to the left-hand side of FIG. 1. The female piece 112 has the recess 114 configured for accommodating the front ferrule 106, the back ferrule 108, a part of the first joint element 110, and the tubing 102, and has a second joint element 116 configured to be joinable to the first joint element 110. The first and the second joint elements 110, 116 may be fastened to one another by a screw connection, as will be explained below in more detail.

A lumen 126 of the front ferrule 106 is dimensioned for accommodating the metal tubing 102 with clearance. A lumen 132 of the back ferrule 108 is dimensioned for accommodating the metal tubing 102 with clearance. The first joint element 110 also has a lumen 150 configured for accommodating the tubing 102 with clearance.

The back ferrule 108 is configured such that upon joining the first joint element 110 to the second joint element 116, the back ferrule 108 exerts a pressing force on the front ferrule 106 to provide a sealing between the front ferrule 106 and the female piece 112. Simultaneously, such a joining has the consequence that the back ferrule 108 exerts a grip force between the male piece 104 and the tubing 102, and that the front ferrule 106 is sealed against the tubing 102 to prevent any fluid leakage. The pressing force has a direction which is longitudinal (parallel to an extension of the tubing 102), whereas the grip force has a direction which is perpendicular to the extension of the tubing 102. As the grip force, the back ferrule 108 generates a positive locking force between the male piece 104 and the tubing 102. This prevents the tubing 102 from laterally sliding after having fixed the two joint elements 110, 116 to one another.

As can be taken from FIG. 1, the front ferrule 106 has a conically tapered front part 118 shaped and dimensioned to correspond to a conical portion 120 of the recess 114 of the female piece 112. Thus, a form closure between the conical front part of the recess 114 on the one hand and the conically tapered front part 118 of the front ferrule 106 may be achieved. Moreover, the front ferrule 106 has a conically tapered back part 122 (which may also be arranged vertically or upright) shaped and dimensioned to correspond to a slanted annular front spring 124 of the back ferrule 108. Although the shapes of the two components 122, 124 are adjusted to match to one another, it is nevertheless possible that upon exertion of corresponding forces, the slanted annular front spring 124 is bent. The slanted annular front spring 124 is adapted for being bent, upon joining the first joint element 110 to the second joint element 116, into an upright position (see arrow 152) to promote a forward motion of the front ferrule 106 towards a stopper portion 118 of the recess 114 of the female piece 112.

An annular back spring 128 is provided as part of the ferrule 108 which is adapted to promote, upon joining the first joint element 110 to the second joint element 116, a forward motion of the tubing 102 towards a stopper portion 148 of the recess 114 of the female piece 112 providing a spring-loading force.

Between the annular back spring 128 and the slanted annular front spring 124 (two disk springs), a sleeve element 130 (a flat spring) is arranged. The sleeve element 130 is conically tapered and has a thicker portion facing the first joint element 110 and has a thinner portion facing the front ferrule 106. A thickness s₁ of the thinner portion is smaller than a thickness s₂ of the thicker portion. These different thickness values allow the sleeve element 130 to improve the force distribution in a longitudinal direction of FIG. 1.

The first joint element 110 is configured for being joined to the second joint element 116 by a screw connection. Thus, in a portion 140, an internal thread of the female piece 112 can be screwed into an external thread in the first joint element 110 of the male piece 104. A user simply has to fasten this screwing connection, and thereby automatically seals the front ferrule 106 against the female element 112 and exerts a grip between the back ferrule 108 and the metal tubing 102.

A slanted surface 134 of the first joint element 110 is configured for exerting a bending moment onto the annular back spring 128 of the back ferrule 108. The slanted surface 134 includes an acute angle α=60° with an outer surface of the tubing 102. With such an acute angle 0<α<90°, a desired bending of the spring components 128, 130 of the back ferrule 108 and of an optional additional spring 136 may be effected. As an alternative to the described configuration, it is possible to that the back spring 128 is slanted and the front spring 124 is upright, or that both the back spring 128 and the front spring 124 are slanted in a way that both of them include an acute angle with the sleeve element 130.

A force transmitting annular metal ring 136 (which supports additional force to front ferrule 106 without increasing radial grip on tubing 102) is arranged slidable on the tubing 102 between the back ferrule 108 and the first joint element 110, and transmits a force exerted by the first joint element 110 to the back ferrule 108. The force transmission element 136 operates as a disk washer and is provided as a separate element which is not integrally formed with a front ferrule 106 and a back ferrule 108. The additional metal ring 136 may be added to increase the sealing force and the elastic deformation independent of the supplied gripping force.

FIG. 1 shows a non-biased state of the fitting 100. In a sealed configuration, a first seal connection is achieved in a region 142 between the front ferrule 106 and the female part 112, and a second sealing is achieved in a region 144 between the front ferrule 106 and the metal tubing 102. In a frontal area 146 of the metal tubing 102, is optionally possible to provide a polymeric coating in order to further suppress sample contamination, since this measure may further increase the sealing performance between the frontal area 146 and the stopper portion 148.

In the following, the force transmission will be explained: After having slid the front ferrule 106 and the back ferrule 108 on the tubing 102 and after having slid the first joint element 110 onto the tubing 102, the first joint element 110 may be connected by screwing with the second joint element 116. This converts the back ferrule 108 into a biased state so that grip is generated between the metal tubing 102 and the back ferrule 108. As the grip force increases the force longitudinal to the capillary axis increases analog and supplies pressure to the sealing regions 146, 148. A corresponding force transmission further results in an upward pivoting of the front spring 124 of the back ferrule 108, as indicated by arrow 152. This presses the polymer material of the front ferrule 106 to a frontward position, i.e. towards the right-hand side of FIG. 1 and supplies pressure to the sealing regions 142, 144.

As can be taken from the three-dimensional view of FIG. 2, the sleeve portion 130 of the back ferrule 108 comprises a plurality of circumferentially equally distributed slits 200. These slits or grooves 200 allow the sleeve diameter to shrink and to grip to the metal tubing 102.

FIG. 1 and FIG. 2 show a high pressure ferrule configuration 100 for providing a sealed flow connection between an open ended duct 146 of the tube 102 or sleeve (for instance enclose fused silica tubing) and a base element is provided, designed for pressure rating beyond 1.000 bar with long-term firmness at an operation temperature above 100° C.

A component of such a fitting 100 is a detachable fixing element (for instance a fitting screw realized as a screwing connection between the joint elements 110 and 116 of FIG. 1).

A ferrule assembly 106, 108 is provided which comprises a polymer typed sealing (front ferrule 106) and a metal typed elastic gripper element (back ferrule 108). This may provide both an unlockable radial grip and a spring biased force against the front ferrule 106 as well as the fixing element when locked. The actual sealing force needed is divided and adjusted for:
a spring biased force to deform and seal the front ferrule 106 and supporting force for creep under compression
a spring biased force to press the tube 102 against the base element

In the following, some advantageous properties of the ferrule configuration 106, 108 will be mentioned:
ferrule 106, 108 position axial repeatable-adjustable on tubing 102
material of the front ferrule 106 may be polymer (for instance PEEK)
material for the back ferrule 108 may be stainless steel with high elastic elongation
the system may have an ability for an elastic radial grip on the tubing 102
spring biased element 124, 128 for the sealing force
spring biased element 128, 136 for pushing the tube 102 against the base element 116 (for instance union)
sticking on tubing 102 as pre-fixation or to support for captivity of the fitting
one piece handling is possible which is simple for a user
exchangeable configuration
low axial extension

The embodiment of FIG. 1, FIG. 2 provides for three simultaneously activatable spring sections 124, 128, 130 on the back ferrule 108:
a first disk spring 124 is provided opposite to the front ferrule 106
a flat second disk spring 128 is provided opposite to the fixing element 110
a concentrically arranged flat spring series 130 is provided in the middle section between disk springs 124, 128

As can be taken from FIG. 2, two or more separating slots 200 may be formed in the middle section 130, for instance arranged in a radial symmetric manner. A longitudinally reinforced middle section 130 may be effective from the first disk spring 124 to the second disk spring 128. A structured surface for the middle section 130 (see reference numeral 200) in opposite to the tubing may be provided to increase the friction force or even build a form closure at the region touching the tubing 102, causing an enhanced grip to the tubing 102. Such a structured surface may be realized with a defined spatial surface roughness, the provision of concentric multiple grooves (respectively rips), a helix groove (respectively a helix rip), a helix groove (respectively a helix rip) with half of the flank lead of the fitting element when screwed. Other configurations of the structured surface are a special coating optionally in combination with one or more of the above provisions. Also a surface hardening may be provided optionally in combination with one or more of the above provisions.

The fixing element 110 may be provided with a conical shape opposite to the flat second disk spring 128. A compression lip may be attached to the front ferrule 106 supporting a defined sliding and clamping along the tube 102. A second disk spring may be arranged in parallel.

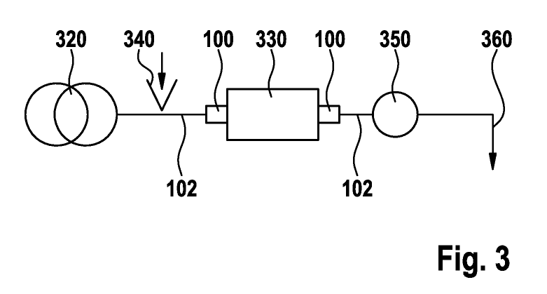

FIG. 3 shows a HPLC (High-Performance Liquid Chromatography) system 300 for a liquid chromatography analysis of a fluidic sample according to an exemplary embodiment.

A pump 320 pumps a mobile phase through a chromatographic column 330 which comprises a stationary phase such as beads made of silica gel. A sample supply unit 340 is arranged between the pump 320 and the chromatographic column 330 in order to inject a fluidic sample into the mobile phase. The stationary phase of the chromatographic column 330 is provided in order to separate components of the fluidic sample which may be pumped through the chromatographic column 330 with a high pressure of, for instance, 1.000 bar. A detector 350 detects the separated components of the fluidic sample. A fractioner 360 can be provided to receive the separated components of the fluidic sample, for instance to conduct them into dedicated containers or into a waste container (not shown).

As can be taken from FIG. 3, fittings 100 are used to connect an inlet and an outlet of the chromatographic column 330 to a metal tubing 102 in a liquid-sealed fashion. Additionally or alternatively, any of the other components shown in FIG. 3 may be connected to such a tubing 102 using a fitting 100.

It should be noted that the term “comprising” does not exclude other elements or features and the “a” or “an” does not exclude a plurality. Also elements described in association with different embodiments may be combined. It should also be noted that reference signs in the claims shall not be construed as limiting the scope of the claims.

1. A fitting (100) for coupling a tubing (102) to another component (330) of a fluidic device (300), the fitting (100) comprising
a male piece (104) having a front ferrule (106) and a back ferrule (108) both being slidable on the tubing (102), the male piece (104) further having a first joint element (110) configured slidably on the tubing (102);
a female piece (112) having a recess (114) configured for accommodating the front ferrule (106) and the tubing (102) and having a second joint element (116) configured to be joinable to the first joint element (110);
wherein the back ferrule (108) is configured in such a manner that, upon joining the first joint element (110) to the second joint element (116), the back ferrule (108) exerts a pressing force on the front ferrule (106) to provide a sealing between the front ferrule (106) and the female piece (112), and the back ferrule (108) exerts a grip force between the male piece (104) and the tubing (102).

2. The fitting (100) according to claim 1,
wherein the front ferrule (106) and the back ferrule (108) are fixedly connected to one another to form a single piece.

3. The fitting (100) according to claim 1 or any one of the above claims,
wherein the front ferrule (106) has a conically tapered front part (118) configured to correspond to a conical portion (120) of the recess (114) of the female piece (112).

4. The fitting (100) according to claim 1 or any one of the above claims,
wherein the front ferrule (106) has a conically tapered back part (122) configured to correspond to a slanted annular front spring (124) of the back ferrule (108).

5. The fitting (100) according to claim 1 or any one of the above claims,
wherein the front ferrule (106) has a lumen (126) configured for accommodating the tubing (102).

6. The fitting (100) according to claim 1 or any one of the above claims,
wherein the front ferrule (106) comprises an elastic material, particularly a polymer material.

7. The fitting (100) according to claim 1 or any one of the above claims,
wherein the back ferrule (108) is configured in such a manner that, upon joining the first joint element (110) to the second joint element (116), the back ferrule (108) exerts a pressing force on the front ferrule (106) to provide a sealing between the front ferrule (106) and the tubing (102).

8. The fitting (100) according to claim 1 or any one of the above claims,
wherein the back ferrule (108) is configured in such a manner that, upon joining the first joint element (110) to the second joint element (116), the back ferrule (108) generates a positive locking force between the male piece (104) and the tubing (102).

9. The fitting (100) according to claim 1 or any one of the above claims,
wherein the back ferrule (108) is configured in such a manner that, upon joining the first joint element (110) to the second joint element (116), the back ferrule (108) exerts a grip force between the back ferrule (108) and the tubing (102).

10. The fitting (100) according to claim 1 or any one of the above claims,
wherein the back ferrule (108) comprises a slanted annular front spring (124) configured to correspond to a conically tapered back part (122) of the front ferrule (106).

11. The fitting (100) according to claim 10,
wherein the slanted annular front spring (124) is adapted for being bent, upon joining the first joint element (110) to the second joint element (116), into or close to an upright position to promote a forward motion of the front ferrule (106) towards a stopper portion (118) of the recess (114) of the female piece (112).

12. The fitting (100) according to claim 1 or any one of the above claims,
wherein the back ferrule (108) comprises an annular back spring (128).

13. The fitting (100) according to claim 12,
wherein the annular back spring (128) is adapted to promote, upon joining the first joint element (110) to the second joint element (116), a forward motion of the tubing (102) towards a stopper portion (148) of the recess (114) of the female piece (112).

14. The fitting (100) according to claims 10 and 12,
wherein the back ferrule (108) comprises a flexible sleeve element (130) connecting the annular back spring (128) with the slanted annular front spring (124).

15. The fitting (100) according to claim 14,
wherein the sleeve element (130) has a structured surface promoting a grip force to mechanically connect the back ferrule (108) with the tubing (102).

16. The fitting (100) according to claim 15,
wherein the structured surface comprises at least one of the group consisting of a plurality of separating slots (200), a plurality of concentrically arranged grooves, a plurality of concentrically arranged rips, a helical groove, and a helical rip.

17. The fitting (100) according to claim 14 or any one of the above claims,
wherein the sleeve element (130) has a functionalized surface promoting a grip force to mechanically connect the back ferrule (108) with the tubing (102).

18. The fitting (100) according to claim 17,
wherein the functionalized surface comprises at least one of the group consisting of a surface coating and a surface hardening.

19. The fitting (100) according to claim 14 or any one of the above claims,
wherein the sleeve element (130) is conically tapered and has a first portion with a first thickness (s₂) facing the first joint element (110) and has a second portion with a second thickness (s₁) facing the front ferrule (106), wherein the first thickness (s₂) is larger than the second thickness (s₁).

20. The fitting (100) according to claim 1 or any one of the above claims,
wherein the back ferrule (108) has a lumen (132) configured for accommodating the tubing (102).

21. The fitting (100) according to claim 1 or any one of the above claims,
wherein the back ferrule (108) comprises an elastic material, particularly a metal sheet.

22. The fitting (100) according to claim 1 or any one of the above claims,
wherein the back ferrule (100) comprises a multiple spring configuration, particularly comprises two disk springs (124, 128) separated by a flat spring (130).

23. The fitting (100) according to claim 1 or any one of the above claims,
wherein the first joint element (110) is configured for being joint to the second joint element (116) by a screw connection.

24. The fitting (100) according to claim 1 or any one of the above claims,
wherein the first joint element (110) comprises an external screw thread configured for a screw connection with an internal screw thread in the recess (114) of the second joint element (116).

25. The fitting (100) according to claim 1 or any one of the above claims,
wherein the first joint element (110) has a lumen (150) configured for accommodating the tubing (102).

26. The fitting (100) according to claim 1 or any one of the above claims,
wherein the first joint element (110) comprises a rigid material, particularly a metal material.

27. The fitting (100) according to claim 1 or any one of the above claims,
wherein the first joint element (110) has a slanted front face (134) configured for exerting a bending moment on an annular back spring (128) of the back ferrule (108).

28. The fitting (100) according to claim 27,
wherein the slanted front face (134) includes an acute angle (α) with an outer surface of the tubing (102).

29. The fitting (100) according to claim 1 or any one of the above claims,
wherein the recess (114) is configured for accommodating the back ferrule (108) and a part of the first joint element (110).

30. The fitting (100) according to claim 1 or any one of the above claims,
wherein the back ferrule (108) is arranged slidable on the tubing (102) between the front ferrule (106) and the first joint element (110).

31. The fitting (100) according to claim 1 or any one of the above claims,
comprising the tubing (102).

32. The fitting (100) according to claim 31,
wherein the tubing (102) comprises at least one of the group consisting of a metal, stainless steel, titan, a plastic, a polymer, glass, and quartz.

33. The fitting (100) according to claim 31 or any one of the above claims,
wherein the tubing (102) has a lumen having a diameter of less than 0.8 mm, particularly of less than 0.2 mm.

34. The fitting (100) according to claim 1 or any one of the above claims,
wherein the male piece (104) comprises an additional spring element (136) arranged slidable on the tubing (102) between the back ferrule (108) and the first joint element (110) to transmit a force exerted by the first joint element (110) to the back ferrule (108).

35. The fitting (100) according to claim 34,
wherein the additional spring element (136) is annularly shaped to correspond to an annular back spring (128) of the back ferrule (108).

36. The fitting (100) according to claim 34 or any one of the above claims,
wherein the additional spring element (136) is provided separately from the back ferrule (108).

37. The fitting (100) according to claim 34 or any one of the above claims,
wherein the additional spring element (136) is integrally formed with the back ferrule (108).

38. The fitting (100) according to claim 1 or any one of the above claims,
wherein the front ferrule (106) and the back ferrule (108) are connected to one another.

39. The fitting (100) according to claim 1 or any one of the above claims,
wherein the back ferrule (108) comprises a multiple spring configuration (124, 128, 130) adapted in such a manner that, upon joining the first joint element (110) to the second joint element (116), the multiple spring configuration (124, 128, 130) exerts a longitudinal pressing force parallel to the tubing (102) on the front ferrule (106) and exerts a grip force on the tubing (102) having a direction perpendicular to the longitudinal pressing force.

40. The fitting (100) according to claim 14 or any one of the above claims,
wherein the sleeve element (130) comprises a plurality of slits (200) to separate a lateral surface of the sleeve element (130) to thereby form a plurality of leaf spring sections between adjacent ones of the plurality of slits (200).

41. A fluidic device (300) for processing a fluidic sample, the fluidic device (300) comprising
a tubing (102) for conducting the fluidic sample;
another component (330) for processing the fluidic sample;
a fitting (100) according to claim 1 or any one of the above claims for coupling the tubing (102) to the other component (330).

42. The fluidic device (300) according to claim 41,
wherein the other component comprises a processing element (330) adapted for interacting with the fluidic sample.

43. The fluidic device (300) according to claim 42,
wherein the processing element (330) is adapted for retaining the fluidic sample being a part of a mobile phase and for allowing other components of the mobile phase to pass the processing element (330).

44. The fluidic device (300) according to claim 42 or any one of the above claims,
wherein the processing element (330) comprises a separation column.

45. The fluidic device (300) according to claim 42 or any one of the above claims,
wherein the processing element (330) comprises a chromatographic column for separating components of the fluidic sample.

46. The fluidic device (300) according to claim 41 or any one of the above claims,
adapted to conduct a liquid fluidic sample through the other component (330).

47. The fluidic device (300) according to claim 41 or any one of the above claims,
adapted to conduct the fluidic sample through the other component (330) with a high pressure.

48. The fluidic device (300) according to claim 41 or any one of the above claims,
adapted to conduct the fluidic sample through the other component (330) with a pressure of at least 100 bar, particularly of at least 500 bar, more particularly of at least 1000 bar.

49. The fluidic device (300) according to claim 42 or any one of the above claims,
wherein at least a part of the processing element (330) is filled with a fluid separating material.

50. The fluidic device (300) according to claim 49,
wherein the fluid separating material comprises beads having a size in the range of 1 μm to 50 μm.

51. The fluidic device (300) according to claim 49 or any one of the above claims,
wherein the fluid separating material comprises beads having pores having a size in the range of 0.02 μm to 0.03 μm.

52. The fluidic device (300) according to claim 41 or any one of the above claims,
adapted as a fluid separation system for separating compounds of the fluidic sample.

53. The fluidic device (300) according to claim 41 or any one of the above claims,
adapted as a fluid purification system for purifying the fluidic sample.

54. The fluidic device (300) according to claim 41 or any one of the above claims,
adapted to analyze at least one physical, chemical and/or biological parameter of at least one compound of the fluidic sample.

55. The fluidic device (300) according to claim 41 or any one of the above claims,
comprising at least one of the group consisting of a sensor device, a device for chemical, biological and/or pharmaceutical analysis, a capillary electrophoresis device, a liquid chromatography device, an HPLC device, a gas chromatography device, a gel electrophoresis device, and a mass spectroscopy device.

56. The fluidic device (300) according to claim 41 or any one of the above claims,
adapted as a microfluidic device.

57. The fluidic device (300) according to claim 41 or any one of the above claims,
adapted as a nanofluidic device.

58. A method of coupling a tubing (102) to another component (330) of a fluidic device (300), the method comprising
sliding a male piece (104) having a front ferrule (106) and a back ferrule (108) on the tubing (102), and sliding a first joint element (110) of the male piece (104) on the tubing (102);
providing a female piece (112) having a recess configured for accommodating the front ferrule (106) and the tubing (102) and having a second joint element (116) configured to be joinable to the first joint element (110);
joining the first joint element (110) to the second joint element (116) in such a manner that the back ferrule (108) exerts a pressing force on the front ferrule (106) to provide a sealing between the front ferrule (106) and the female piece (112), and that the back ferrule (108) exerts a grip force between the male piece (104) and the tubing (102).
